(19) United States
(12) Patent Application Publication
(10) Pub. No.: US 2022/0105897 A1
(43) Pub. Date: Apr. 7, 2022

(54) VEHICLE AND PORTABLE DEVICE COMMUNICATION

(71) Applicant: Ford Global Technologies, LLC, Dearborn, MI (US)

(72) Inventor: Byungho Cha, Mountain View, CA (US)

(73) Assignee: Ford Global Technologies, LLC, Dearborn, MI (US)

(21) Appl. No.: 17/062,857

(22) Filed: Oct. 5, 2020

(51) Int. Cl. B60R 25/24; H04L 29/12; H04L 29/08; G06F 3/0488; G06F 3/0481; G06F 1/3234; H04L 9/08; B60R 25/01

(52) U.S. Cl. CPC B60R 25/24; H04L 61/2038; H04L 67/141; G06F 3/0488; G06F 3/04817; H04L 2209/84; H04L 9/0861; H04L 9/0819; B60R 25/01; H04L 2209/80; G06F 1/3265

(57) ABSTRACT

A portable computing device includes a processor and a memory, the memory storing instructions executable by the processor to initiate communication between the portable computing device and a vehicle computer via a first access address provided by the vehicle computer, then, based on at least one of (1) a user input to the portable computing device, or (2) a change of an output of the portable computing device, obtain from the vehicle computer a second access address for the vehicle computer, and provide a command to the vehicle computer to actuate one or more vehicle components via the second access address.

### BACKGROUND

Portable devices, such as mobile phones and wearable devices, can communicate with vehicles. The portable devices can transmit data and/or messages to the vehicles, and the vehicles can transmit data and/or messages to the portable devices. These communications can occur over a wireless network. Such networks typically have dedicated bandwidth for communications.

### BRIEF DESCRIPTION OF THE DRAWINGS

FIG. 1 is a diagram of an example system for communicating between a vehicle and a portable device.

FIG. 2 is a view of an example portable device communicating with an example vehicle.

FIG. 3 is a diagram of an example process for communicating between the vehicle and the portable device.

FIG. 4 is a diagram of another example process for communicating between the vehicle and the portable device.

### DETAILED DESCRIPTION

A system includes a portable computing device including a processor and a memory, the memory storing instructions executable by the processor to initiate communication between the portable computing device and a vehicle computer via a first access address provided by the vehicle computer, then, based on at least one of (1) a user input to the portable computing device, or (2) a change of an output of the portable computing device, obtain from the vehicle computer a second access address for the vehicle computer, and provide a command to the vehicle computer to actuate one or more vehicle components via the second access address.

The instructions can further include instructions to input an encryption key to an address generator program to obtain the second access address, the encryption key being a numeric key stored in both the portable computing device and the vehicle computer.

The instructions can further include instructions to generate the encryption key upon initiating communication between the portable computing device and the vehicle computer.

The instructions can further include instructions to generate the encryption key upon identifying the user input to the portable computing device or the change of the output of the portable computing device.

The instructions can further include instructions to send the generated encryption key to the vehicle computer via the first access address.

The instructions can further include instructions to receive the encryption key from the vehicle computer via the first access address.

The address generator program can be a Resolvable Private Address program, and the encryption key can be an Identity Resolving Key.

The instructions can further include instructions to obtain the second access address upon determining that an elapsed time from generation of the first access address exceeds a time threshold.

The instructions can further include instructions to cease communication with the vehicle computer upon identifying the user input to the portable computing device or the change of the output of the portable computing device, request the second access address from the vehicle computer, obtain the second access address, and reestablish communication with the vehicle computer via the second access address.

The instructions can further include instructions to identify the user input on the portable computing device as an input to actuate one or more vehicle components and to provide a command to the vehicle computer based on the user input via the first access address.

The instructions can further include instructions to generate the second access address when the identified user input is an input other than the input to actuate one or more vehicle components.

The user input to the portable computing device can be a haptic input to an icon on a display of the portable computing device.

The change of the output of the portable computing device can be a transition to a darkened power-saving display.

The system can further include the vehicle computer, wherein the vehicle computer is programmed to generate the second access address upon detecting the portable computing device cease communication with the vehicle computer and then receiving a request to reestablish communication with the vehicle computer.

A method includes initiating communication between the portable computing device and a vehicle computer via a first access address provided by the vehicle computer, then, based on at least one of (1) a user input to the portable computing device, or (2) a change of an output of the portable computing device, obtaining from the vehicle computer a second access address for the vehicle computer, and providing a command to the vehicle computer to actuate one or more vehicle components via the second access address.

The method can further include inputting an encryption key to an address generator program to obtain the second access address, the encryption key being a numeric key stored in both the portable computing device and the vehicle computer.

The method can further include generating the encryption key upon initiating communication between the portable computing device and the vehicle computer.

The method can further include generating the encryption key upon identifying the user input to the portable computing device or the change of the output of the portable computing device.

The method can further include sending the generated encryption key to the vehicle computer via the first access address.

The method can further include receiving the encryption key from the vehicle computer via the first access address.

The method can further include obtaining the second access address upon determining that an elapsed time from generation of the first access address exceeds a time threshold.

The method can further include ceasing communication with the vehicle computer upon identifying the user input to the portable computing device or the change of the output of the portable computing device, requesting the second access address from the vehicle computer, obtaining the second access address, and reestablishing communication with the vehicle computer via the second access address.

The method can further include identifying the user input on the portable computing device as an input to actuate one or more vehicle components and providing a command to the vehicle computer based on the user input via the first access address.

The method can further include generating the second access address when the identified user input is an input other than the input to actuate one or more vehicle components.

The method can further include generating the second access address in the vehicle computer upon detecting the portable computing device cease communication with the vehicle computer and then receiving a request to reestablish communication with the vehicle computer.

A system includes a portable computing device and a vehicle computer including a processor and a memory, the memory storing instructions executable by the processor to initiate communication with the portable computing device via a first access address, receive a request from the portable computing device to generate a second access address, reestablish communication between the portable computing device via the second access address, and receive a command from the portable computing device to actuate one or more vehicle components via the second access address.

The instructions can further include instructions to generate the second access address upon detecting the portable computing device cease communication with the vehicle computer and then receiving a request from the portable computing device to reestablish communication with the vehicle computer.

The instructions can further include instructions to input an encryption key to an address generator program to generate the second access address, the encryption key being a numeric key stored in both the portable computing device and the vehicle computer.

The instructions can further include instructions to generate the encryption key upon initiating communication between the portable computing device and the vehicle computer.

The instructions can further include instructions to generate the second access address upon determining that an elapsed time from generation of the first access address exceeds a time threshold.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

Communications between a portable computing device and a vehicle computer occur over a communications protocol specified between the portable computing device and the vehicle computer. One such protocol is Bluetooth® Low Energy (BLE). Communications over BLE can be secured by changing an access address of communication between the portable device and the vehicle computer. Changing the access address requires the portable device to perform a plurality of computations, which consumes energy from a battery of the portable device. Frequent changes to the access address can drain the battery of the portable device.

As explained herein, changing the access address upon detecting a specified change in operation of an application executing on the portable device advantageously provides security for communications between the portable device and the vehicle computer while reducing the amount of energy consumed to change the access address. That is, in examples of changes to application operation discussed further below, when a user provides input to the portable device or a program on the portable device changes an output of the portable device, the portable device can update the access address. By changing an access address only upon changes in application operation, the portable device reduces the total number of changes to the access address during communication with the vehicle computer, while still changing the access address often enough to secure communications with the vehicle computer. Thus, battery consumption of the portable device is reduced.

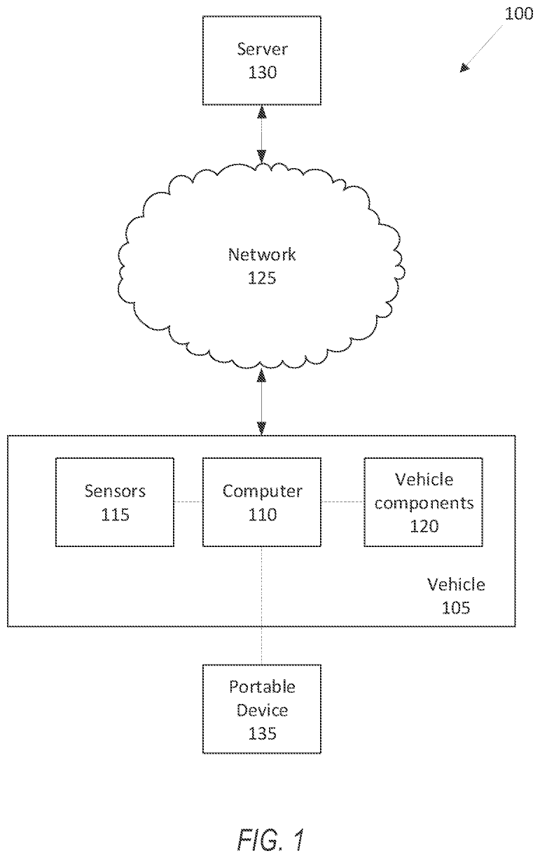

FIG. 1 illustrates an example system 100 for operating a vehicle 105. A computer 110 in the vehicle 105 is programmed to receive collected data from one or more sensors 115. For example, vehicle 105 data may include a location of the vehicle 105, data about an environment around a vehicle, data about an object outside the vehicle such as another vehicle, etc. A vehicle 105 location is typically provided in a conventional form, e.g., geo-coordinates such as latitude and longitude coordinates obtained via a navigation system that uses the Global Positioning System (GPS). Further examples of data can include measurements of vehicle 105 systems and components, e.g., a vehicle 105 velocity, a vehicle 105 trajectory, etc.

The computer 110 is generally programmed for communications on a vehicle 105 network, e.g., including a conventional vehicle 105 communications bus such as a CAN bus, LIN bus, etc., and or other wired and/or wireless technologies, e.g., Ethernet, WIFI, etc. Via the network, bus, and/or other wired or wireless mechanisms (e.g., a wired or wireless local area network in the vehicle 105), the computer 110 may transmit messages to various devices in a vehicle 105 and/or receive messages from the various devices, e.g., controllers, actuators, sensors, etc., including sensors 115. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include a dedicated electronic circuit including an ASIC that is manufactured for a particular operation, e.g., an ASIC for processing sensor data and/or communicating the sensor data. In another example, computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve information stored by the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle 105 network or bus, e.g., data relating to vehicle speed, acceleration, location, subsystem and/or component status, etc. Further, other sensors 115 could include cameras, motion detectors, etc., i.e., sensors 115 to provide data for evaluating a position of a component, evaluating a slope of a roadway, etc. The sensors 115 could, without limitation, also include short range radar, long range radar, LIDAR, and/or ultrasonic transducers.

Collected data can include a variety of data collected in a vehicle 105. Examples of collected data are provided above, and moreover, data are generally collected using one or more sensors 115, and may additionally include data calculated therefrom in the computer 110, and/or at the server 130. In general, collected data may include any data that may be gathered by the sensors 115 and/or computed from such data.

The vehicle 105 can include a plurality of vehicle components 120. In this context, each vehicle component 120 includes one or more hardware components adapted to perform a mechanical function or operation—such as moving the vehicle 105, slowing or stopping the vehicle 105, steering the vehicle 105, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 120 can include computing devices, e.g., electronic control units (ECUs) or the like and/or computing devices such as described above with respect to the computer 110, and that likewise communicate via a vehicle 105 network.

The system 100 can further include a network 125 connected to a server 130. The computer 110 can further be programmed to communicate with one or more remote sites such as the server 130, via the network 125, such remote site possibly including a processor and a memory. The network 125 represents one or more mechanisms by which a vehicle computer 110 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The system 100 includes a portable device 135. The portable device 135 may be any one of a variety of devices, such as computing devices including a processor and a memory, that have communication capabilities to communicate over the network 125. For example, the portable device 135 may be a wearable device, e.g. a watch or a smart watch, a smartphone, a tablet, a personal digital assistant, a watch-phone pairing, a vibrating apparatus, etc. that includes capabilities for wireless communications using IEEE 802.11, Bluetooth®, UWB, NFC, and/or cellular communications protocols. Further, the portable device 135 may use such communications capabilities to communicate directly with a vehicle computer 110, e.g., using Bluetooth®.

The portable device 135 can communicate with the computer 110 via an access address. An “access address” is a set of numeric values that the portable device 135 and the computer 110 append to each communication to confirm that the communications are intended for the portable device 135 and the computer 110. The access address can be a previously generated set of numeric values stored in a memory of the computer 110 and broadcast to the portable device 135. That is, the computer 110 and the portable device 135 can, upon receiving a packet of data including the access address, accept the packet knowing that the packet originated from the computer 110 or the portable device 135. The access address can be generated upon initiating communication between the computer 110 and the portable device 135, i.e., upon “pairing” the computer 110 and the portable device 135 via Bluetooth® Low Energy. When the computer 110 and the portable device 135 have previously initiated communication (i.e., when the computer 110 and the portable device 135 have previously been paired), the access address can be a previously generated access address generated upon the first communication between the computer 110 and the portable device 135.

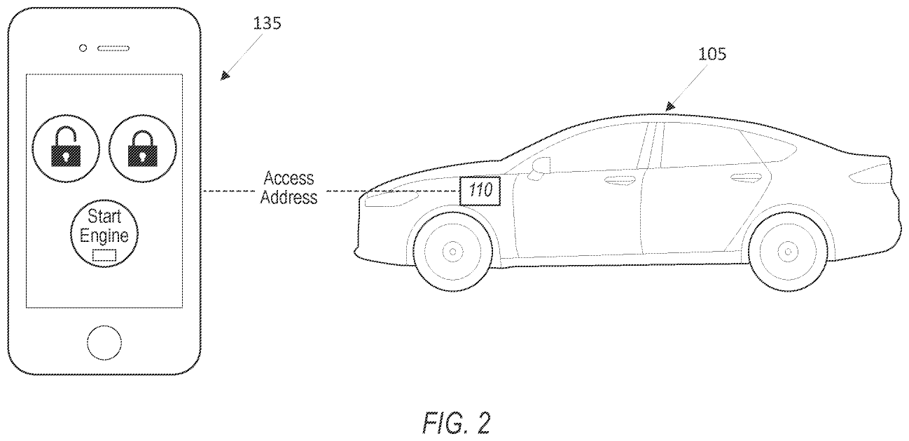

FIG. 2 is a view of an example portable device 135 communicating with a vehicle computer 110. As described above, the portable device 135 and the vehicle computer 110 use an access address stored in the vehicle computer 110 and broadcast by the vehicle computer 110 to transmit messages via, e.g., Bluetooth® Low Energy. The access address may be intercepted by a third party eavesdropping device, e.g., in what is sometimes referred to as a man-in-the-middle attack. Thus, to prevent a third party from sending messages to the computer 110 and the portable device 135 with the access address, the computer 110 and the portable device 135 can change the access address periodically. That is, upon changing the access address, the computer 110 and the portable device 135 can ignore messages with the previous access address and only accept messages with the new access address.

The portable device 135 can initiate communication between the portable device 135 and the computer 110 via a first access address provided by the computer 110. Alternatively, the computer 110 can initiate communication with the portable computing device 135 via the first access address. The first access address can be a default access address that the computer 110 broadcasts to nearby devices such as the portable device 135. That is, the computer 110 can initially communicate with the portable device 135 via the first access address.

The portable device 135 can provide a command to the vehicle computer 110. For example, the portable device 135 can provide a command to the vehicle computer 110 to actuate one or more vehicle components 120, e.g., to actuate a lock on a door, to activate a propulsion, to actuate a climate controller, etc. A user can provide input to the portable device 135, e.g., to a touchscreen of the portable device 135. Based on the input, the portable device 135 can provide the command to the vehicle computer 110. The portable device 135 can provide the command via the access address. Thus, the user can actuate the vehicle components 120 remotely from the vehicle 105.

The computer 110 and/or the portable device 135 can change the access address used to communicate between the computer 110 and the portable device 135. That is, to prevent eavesdroppers from intercepting communications between the computer 110 and the portable device 135, at least one of the computer 110 or the portable device 135 can request to change the access address. Frequently changing the access address reduces the likelihood that an eavesdropper would have a current access address. Changing the access address can consume energy from a battery of the portable device 135, so reducing the total number of changes to the access address during communication with the vehicle computer 110 can reduce power consumption and extend and/or preserve the battery life of the portable device 135.

The portable device 135 can determine to change the access address based on a change in operation of an application on the portable device 135. A “change” in operation of the application is a new input or output from a current input or output of the portable device 135. The change in operation can include an input to the portable device, the input being a physical input from a user to a display of the portable device 135. That is, the user can provide a physical input to an icon on the display of the portable device 135, and the portable device can determine to change the access address upon receiving the input to the display of the portable device 135. The physical input can include, e.g., input to an icon to provide a command to actuate one or more components 120, input to an icon to close a current application, input to an icon to open another application, etc.

The change in operation can include a change of output of the portable device 135, e.g., a change to one or more visible items on a display of the portable device 135. That is, the output to the display of the portable device 135 can change based on whether the portable device 135 has received input, and the portable device 135 can determine to change the access address when one or more visible items on the display of the portable device 135 change. For example, the change in the display of the portable device 135 can be a transition of the display to a darkened power-saving display when no input has been provided to the display for an elapsed time exceeding a time threshold. In another example, the change in the display of the portable device 135 can be a transition to a default set of icons on the display, i.e., a “home screen.” That is, the “change in operation” of the application can include a user input to the display to the portable device 135 and/or a transition of the display to a darkened power-saving display.

After detecting the change in the application, the portable device 135 can obtain a second access address. The portable device 135 can obtain the second access address from the vehicle computer 110. Alternatively, the portable device 135 can generate the second access address and send a message to the vehicle computer 110 requesting to communicate via the second access address. Alternatively or additionally, the portable device 135 can obtain the second access address upon determining that an elapsed time from generation of the first access address exceeds a time threshold. That is, the portable device 135 can obtain the second access address and predetermine intervals of time determined by a manufacturer and/or a security program to reduce the likelihood that an eavesdropper would have a current access address.

The user can provide input to the portable device 135 to actuate one or more vehicle components 120, as described above, and as may be known via various “mobile apps,” i.e., applications that run on smartphones or the like to provide access to and/or control of a vehicle. For example, as shown in FIG. 2, the portable device 135 can display a plurality of icons to which the user can provide input. The user can provide input to one of the icons to, e.g., lock a door of the vehicle 105, unlock a door of the vehicle 105, remotely start a propulsion of the vehicle 105, etc. The user input can be a haptic input to an icon on the display of the portable computing device 135, e.g., a touch, a swipe, a pinch, etc. The portable device 135 and/or the vehicle computer 110 can generate the second access address upon identifying user input that is an input other than input to actuate the vehicle components 120. That is, while the user is providing input to actuate the components 120, the computer 110 and the portable device 135 can communicate over a current access address. When the user input is input other than input to actuate the components 120, such as input to close an application that provides commands to the components 120, the computer 110 and/or the portable device 135 can determine that the user no longer intends to actuate the components 120 and can generate the second access address. Thus, while the user is communicating with the computer 110, the portable device 135 and the computer 110 use the current access address, and when the user no longer intends to communicate with the computer 110, the computer 110 and/or the portable device 135 can generate the second access address.

The computer 110 and/or the portable device 135 can generate the second access address by ceasing communication between the computer 110 and/or the portable device 135. To “cease” communication means to disconnect the portable device 135 from communication with the computer 110 and end a current communication session between the portable device 135 and the computer 110. For example, the portable device 135 can send a message to the computer 110 via Bluetooth® Low Energy protocol to end a current communication session between the portable device 135 and the computer 110. That is, upon ceasing communication, the computer 110 and/or the portable device 135 can determine to use a different access address to communicate than the access address used prior to ceasing communication. Using a new access address each time the computer 110 and the portable device 135 initiate communication prevents eavesdroppers from using a previously determined access address to intercept communications. The portable device 135 can cease communication with the computer 110 upon identifying the user input to the portable device 135 or the change of output of the portable device 135, as described above. Upon ceasing communication, the portable device 135 can request the second access address from the computer 110. Upon obtaining the second access address from the computer 110, the portable device 135 can reestablish communication with the computer 110 via the second access address.

The computer 110 can be programmed to generate the second access address upon determining that the portable computing device 135 has ceased communication with the computer 110, i.e., has ended a current communication session with the computer 110. If the computer 110 attempts to reestablish communication with the portable device 135 with the current access address, the portable device 135 can transmit a request to the computer 110 via the current access address to generate the second access address. Upon generating the second access address, which as explained below can be done in a secure manner, the computer 110 can reestablish communication with the portable device 135 via the second access address. The computer 110 can receive a command from the portable device 135 to actuate one or more vehicle components 120 via the second access address. Upon receiving the command, the computer 110 can actuate the one or more components 120 and one more sensors 115 that collect data used in actuation of the components 120. For example, if the computer 110 receives a command to actuate a propulsion 120, the computer 110 can actuate a fuel level sensor 115 in a fuel tank, an air/fuel ratio sensor 115, a fuel injector sensor 115, etc., to collect data that the computer 110 can use to activate the propulsion 120.

The computer 110 and/or the portable device 135 can generate the second access address using an address generator program. An “address generator program” is an algorithm or method to generate an access address. For example, the address generator program can be a Resolvable Private Address (RPA) program that generates an access address from an input random number and an input numeric key. The address generator program generates a randomly generated number and a hash and concatenates the random number and the hash to generate the access address. A “hash” is an output of a “hash” function that outputs a unique string of alphanumeric bits for a specific input numeric key. That is, while the hash appears random, only the specific numeric key can produce the specific hash. The randomly generated number can be generated using a convention pseudorandom number generator, e.g., a stream cipher, a Mersenne Twister, an AES block cipher, etc.

The computer 110 and/or the portable device 135 can input an encryption key to the address generator program to generate the second access address. An “encryption key” is a numeric value stored in both the portable device 135 and the computer 110, e.g., a cryptographic public key. The computer 110 and/or the portable device 135 can generate the encryption key upon initiating communication and can share the encryption key with the other of the computer 110 or the portable device 135. That is, the computer 110 and the portable device 135 can store the same encryption key. When the portable device 135 generates the encryption key, the portable device 135 can send the generated encryption key to the computer 110 via the first access address. When the computer 110 generates the encryption key, the portable device 135 can receive the encryption key from the computer 110 via the first access address. Alternatively or additionally, the portable device 135 can generate the encryption key upon identifying the change to operation of the portable device 135.

The encryption key can be an Identity Resolving Key (IRK). An IRK is a key used to generate an access address with the address generator program, as described above. Each portable device 135 can include a unique IRK identifying the portable device 135. The portable device 135 and/or the computer 110 can input the IRK to the hash function of the address generator program to generate an access address. That is, the output of the address generator function with the IRK input can be unique to the specific portable device 135 from which the IRK is received. The portable device 135 can share the IRK with the computer 110 with a conventional cryptographic protocol, e.g., Advanced Encryption Standard (AES), RSA encryption, etc.

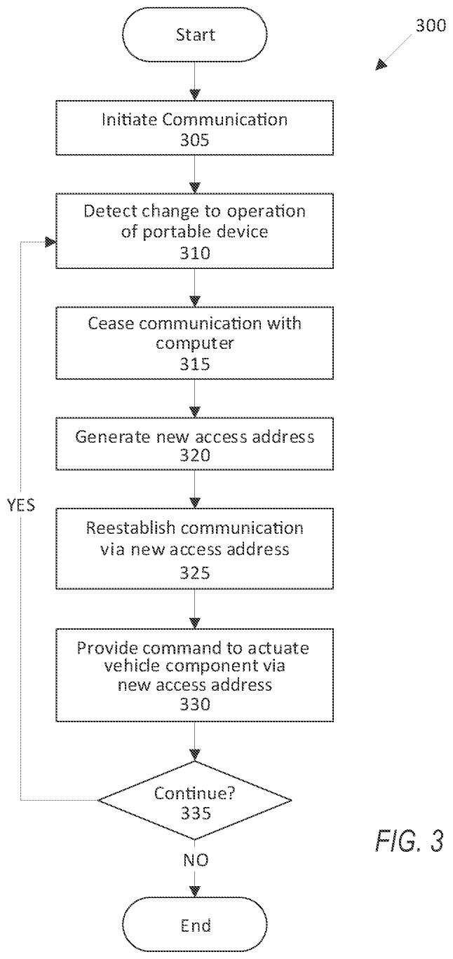

FIG. 3 is a diagram of an example process 300 for communicating between a vehicle computer 110 and a portable computing device 135. The process 300 begins in a block 305, in which the portable device 135 initiates communication with the vehicle computer 110 via a first access address. The vehicle computer 110 can broadcast an access address to nearby devices, and the portable device 135 requests to establish communication with the vehicle computer 110 via the access address. As described above, an access address is a set of numeric values that the portable device 135 and the computer 110 append to each communication to confirm that the communications are intended for the portable device 135 and the computer 110.

Next, in a block 310, the portable device 135 detects a change to operation of the portable device 135. As described above, the portable device 135 can identify a change to operation of the portable device 135 is a new input or output from a current input or output of the portable device 135. The change to the operation can be a change to an application on the portable device 135 that can result in a change or changes to the display screen. For example, the portable device 135 can detect a transition of the display to a darkened, power-saving mode. In another example, the portable device 135 can detect user input to an icon on the display.

Next, in a block 315, the portable device 135 ceases communication with the computer 110. That is, the portable device 135 ceases communication with the computer 110 via the current access address. The portable device 135 can send a message to the computer 110 that the portable device 135 will no longer accept messages with the current access address, ending communications between the portable device 135 and the computer 110 via the current access address.

Next, in a block 320, the portable device 135 and/or the computer 110 generate a new access address. The portable device 135 and/or the computer 110 can generate the new access address with an address generator program. As described above, the address generator program can be a conventional algorithm that generates an access address from an input numeric value. For example, the address generator program can generate a pseudorandom number and an output of a hash function (i.e., a “hash”), and the access address can be the concatenation of the pseudorandom number and the hash.

Next, in a block 325, the portable device 135 reestablishes communication with the computer 110 via the new access address. The portable device 135 or the computer 110 can send a message to the other of the portable device 135 and the computer 110 with the new access address. Then, the portable device 135 and the computer 110 can communicate via the new access address.

Next, in a block 330, the portable device 135 provides a command to the computer 110 to actuate one or more vehicle components 120. As described above, a user can provide input to the portable device 135 to actuate one or more vehicle components 120, and the portable device 135 can provide a command to the computer 110 to actuate the one or more vehicle components 120 based on the user input. The computer 110 can, based on the command, actuate the one or more vehicle components 120 requested by the user.

Next, in a block 335, the portable device 135 determines whether to continue the process 300. For example, the portable device 135 can determine to continue the process 300 when the portable device 135 is within transmission range of Bluetooth® Low Energy communications with the computer 110. If the portable device 135 determines to continue, the process 300 returns to the block 310. Otherwise, the process 300 ends.

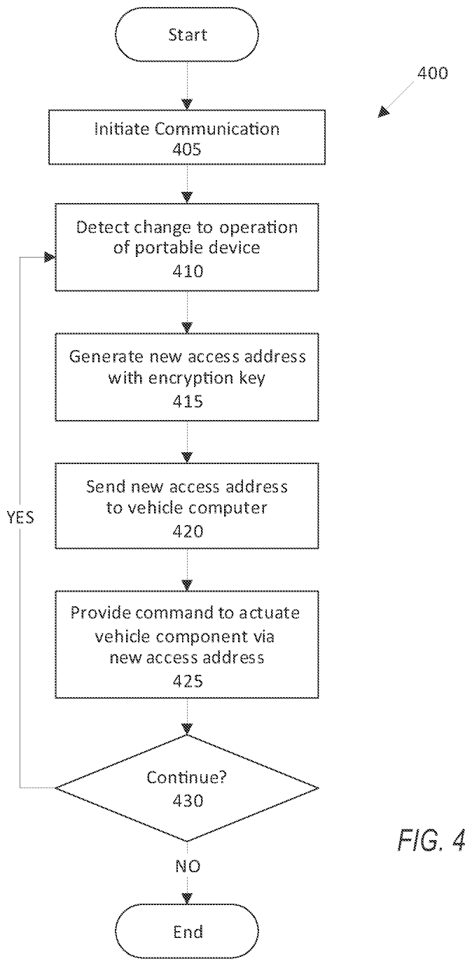

FIG. 4 is a diagram of another example process 400 for communicating between a vehicle computer 110 and a portable computing device 135. The process 400 begins in a block 405, in which the portable device 135 initiates communication with the vehicle computer 110 via a first access address. As described above, the vehicle computer 110 can broadcast an access address to nearby devices, and the portable device 135 requests to establish communication with the vehicle computer 110 via the access address.

Next, in a block 410, the portable device 135 detects a change to operation of the portable device 135. As described above, the portable device 135 can identify changes to an application on the portable device 135 that result in a change to output by the portable device 135. For example, the portable device 135 can detect a transition of the display to a darkened power-saving display mode as a change in output of the portable device 135. In another example, the portable device 135 can detect physical user input to a portion of the display on which an icon is shown.

Next, in a block 415, the portable device 135 and/or the computer 110 generate a new access address with an encryption key. As described above, the portable device 135 and/or the computer 110 can input an encryption key that is a numeric string into an address generator program to generate the new access address. For example, the encryption key can be an Identity Resolving Key (IRK), and the address generator program can be a Resolvable Private Address algorithm.

Next, in a block 420, the portable device 135 or the computer 110 can send the new access address to the other of the portable device 135 and the computer 110. For example, the portable device 135 or the computer 110 can broadcast the new access address, and the other of the portable device 135 and the computer 110 can initiate communications via the new access address. Then, the portable device 135 and the computer 110 can communicate via the new access address.

Next, in a block 425, the portable device 135 provides a command to the computer 110 to actuate a vehicle component 120 via the new access address. As described above, a user can provide input to the portable device 135 to actuate one or more vehicle components 120, and the portable device 135 can provide a command to the computer 110 to actuate the one or more vehicle components 120 based on the user input. The computer 110 can, based on the command, actuate the one or more vehicle components 120 requested by the user.

Next, in a block 430, the portable device 135 determines whether to continue the process 400. For example, the portable device 135 can determine to continue the process 400 when the portable device 135 is within transmission range of Bluetooth® Low Energy communications with the computer 110. If the portable device 135 determines to continue, the process 400 returns to the block 410. Otherwise, the process 400 ends.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a portable computing device including a processor and a memory, the memory storing instructions executable by the processor to:
initiate communication between the portable computing device and a vehicle computer via a first access address provided by the vehicle computer;
then based on at least one of (1) a user input to the portable computing device, or (2) a change of an output of the portable computing device, obtain from the vehicle computer a second access address for the vehicle computer; and
provide a command to the vehicle computer to actuate one or more vehicle components via the second access address.

2. The system of claim 1, wherein the instructions further include instructions to input an encryption key to an address generator program to obtain the second access address, the encryption key being a numeric key stored in both the portable computing device and the vehicle computer.

3. The system of claim 2, wherein the instructions further include instructions to generate the encryption key upon initiating communication between the portable computing device and the vehicle computer.

4. The system of claim 2, wherein the instructions further include instructions to generate the encryption key upon identifying the user input to the portable computing device or the change of the output of the portable computing device.

5. The system of claim 4, wherein the instructions further include instructions to send the generated encryption key to the vehicle computer via the first access address.

6. The system of claim 2, wherein the instructions further include instructions to receive the encryption key from the vehicle computer via the first access address.

7. The system of claim 2, wherein the address generator program is a Resolvable Private Address program, and the encryption key is an Identity Resolving Key.

8. The system of claim 1, wherein the instructions further include instructions to obtain the second access address upon determining that an elapsed time from generation of the first access address exceeds a time threshold.

9. The system of claim 1, wherein the instructions further include instructions to:
cease communication with the vehicle computer upon identifying the user input to the portable computing device or the change of the output of the portable computing device;
request the second access address from the vehicle computer;
obtain the second access address; and
reestablish communication with the vehicle computer via the second access address.

10. The system of claim 1, wherein the instructions further include instructions to identify the user input on the portable computing device as an input to actuate one or more vehicle components and to provide a command to the vehicle computer based on the user input via the first access address.

11. The system of claim 10, wherein the instructions further include instructions to generate the second access address when the identified user input is an input other than the input to actuate one or more vehicle components.

12. The system of claim 1, wherein the user input to the portable computing device is a haptic input to an icon on a display of the portable computing device.

13. The system of claim 1, wherein the change of the output of the portable computing device is a transition to a darkened power-saving display.

14. The system of claim 1, further comprising the vehicle computer, wherein the vehicle computer is programmed to generate the second access address upon detecting the portable computing device cease communication with the vehicle computer and then receiving a request to reestablish communication with the vehicle computer.

15. A system, comprising:
a portable computing device; and
a vehicle computer including a processor and a memory, the memory storing instructions executable by the processor to:
initiate communication with the portable computing device via a first access address;
receive a request from the portable computing device to generate a second access address;
reestablish communication between the portable computing device via the second access address; and
receive a command from the portable computing device to actuate one or more vehicle components via the second access address.

16. The system of claim 15, wherein the instructions further include instructions to generate the second access address upon detecting the portable computing device cease communication with the vehicle computer and then receiving a request from the portable computing device to reestablish communication with the vehicle computer.

17. The system of claim 15, wherein the instructions further include instructions to input an encryption key to an address generator program to generate the second access address, the encryption key being a numeric key stored in both the portable computing device and the vehicle computer.

18. The system of claim 17, wherein the instructions further include instructions to generate the encryption key upon initiating communication between the portable computing device and the vehicle computer.

19. The system of claim 17, wherein the address generator program is a Resolvable Private Address program, and the encryption key is an Identity Resolving Key.

20. The system of claim 15, wherein the instructions further include instructions to generate the second access address upon determining that an elapsed time from generation of the first access address exceeds a time threshold.
